(19) United States
(12) Patent Application Publication
(10) Pub. No.: US 2025/0334605 A1
(43) Pub. Date: Oct. 30, 2025

(54) METHOD AND APPARATUS FOR SIMULTANEOUS MEASUREMENT OF FLOW-FIELD VELOCITY AND TEMPERATURE, AND STORAGE MEDIUM

(71) Applicant: Beihang University, Beijing (CN)

(72) Inventors: Yang XU, Beijing (CN); Rong TIAN, Beijing (CN); Yichen ZHU, Beijing (CN); Hanbin WANG, Beijing (CN); Chong PAN, Beijing (CN); Jinjun WANG, Beijing (CN)

(21) Appl. No.: 19/187,249

(22) Filed: Apr. 23, 2025

(30) Foreign Application Priority Data
Apr. 25, 2024 (CN) 202410508023.7

(51) Int. Cl. G01P 5/00; G01D 21/02; G01K 13/02; G01P 5/20; G01P 5/22; G01P 13/04

(52) U.S. Cl. CPC G01P 5/001; G01D 21/02; G01K 13/026; G01P 5/20; G01P 5/22; G01P 13/045

(57) ABSTRACT

The present application provides a method and apparatus for simultaneous measurement of flow-field velocity and temperature, and a storage medium. The method includes: determining a motion trajectory and a gray-level change of a target temperature-sensitive phosphorescent particle in particle timing frame images; determining a velocity of the target temperature-sensitive phosphorescent particle based on the motion trajectory of the target temperature-sensitive phosphorescent particle in the particle timing frame images; determining a decay-slope constant of the target temperature-sensitive phosphorescent particle based on the gray-level change of the target temperature-sensitive phosphorescent particle in the particle timing frame images; determining a temperature of the target temperature-sensitive phosphorescent particle based on the decay-slope constant of the target temperature-sensitive phosphorescent particle and a preset correspondence; and determining a velocity and a temperature of a flow field to be measured based on the velocity and the temperature of the target temperature-sensitive phosphorescent particle.

### CROSS-REFERENCE TO RELATED PRESENT DISCLOSURE

This patent application claims the benefit and priority of Chinese Patent Application No. 2024105080237 filed with the China National Intellectual Property Administration on Apr. 25, 2024, the disclosure of which is incorporated by reference herein in its entirety as part of the application.

### TECHNICAL FIELD

The present application relates to the field of measurement technologies, and in particular to a method and apparatus for simultaneous measurement of flow-field velocity and temperature, and a storage medium.

### BACKGROUND

In engineering fields, such as aerospace, electrical and electronic engineering, energy production, there are various complex scenarios where heat transfer and fluid flow are inter-coupled, such as film cooling of engine blades, near-wall heat flow in hypersonic flights, and microfluidic cooling of electronic devices. These fluid flow processes involve the interaction of multiple parameters such as a temperature and a velocity. Simultaneous measurement of a velocity and temperature of a flow field helps to deepen the understanding of the coupling mechanism between heat transfer and fluid flow.

At present, individual flow-field velocity measurement and temperature measurement means are relatively mature. In the existing technology, a velocity at a single point in fluid flow is generally measured using devices such as hot-wire or laser Doppler velocimetry, while temperatures at various points in the fluid flow are measured using methods such as thermocouples or laser-induced fluorescence.

However, technologies for simultaneous measurement of the flow-field velocity and temperature are still in the development stage. The existing methods for simultaneous measurement of flow-field velocity and temperature have technical problems of a limited measurement range and large errors in velocity and temperature measurement.

### SUMMARY

The present application provides a method and apparatus for simultaneous measurement of flow-field velocity and temperature, and a storage medium, so as to solve the technical problem of large errors in velocity and temperature measurement existing in the existing technology.

In a first aspect, the present application provides a measurement method for simultaneous measurement of flow-field velocity and temperature. The method includes:
determining a motion trajectory and a gray-level change of a target temperature-sensitive phosphorescent particle in particle timing frame images, where the particle timing frame images are images obtained by performing continuous multi-frame sampling for a phosphorescence decay process of the target temperature-sensitive phosphorescent particle in a flow field to be measured;
determining a velocity of the target temperature-sensitive phosphorescent particle based on the motion trajectory of the target temperature-sensitive phosphorescent particle in the particle timing frame images;
determining a decay-slope constant of the target temperature-sensitive phosphorescent particle based on the gray-level change of the target temperature-sensitive phosphorescent particle in the particle timing frame images;
determining a temperature of the target temperature-sensitive phosphorescent particle based on the decay-slope constant of the target temperature-sensitive phosphorescent particle and a preset correspondence, where the correspondence represents a correspondence between a decay-slope constant and a temperature of a temperature-sensitive phosphorescent particle; and
determining a velocity and a temperature of the flow field to be measured based on the velocity of the target temperature-sensitive phosphorescent particle and the temperature of the target temperature-sensitive phosphorescent particle.

In a possible implementation of the first aspect, the determining a motion trajectory and a gray-level change of a target temperature-sensitive phosphorescent particle in particle timing frame images includes:
performing enhancement processing on an initial particle timing frame image to obtain a first initial particle timing frame image;
performing dilation processing on the first initial particle timing frame image to obtain a second initial particle timing frame image;
comparing the first initial particle timing frame image with the second initial particle timing frame image to determine initial coordinates and gray levels of initial temperature-sensitive phosphorescent particles; and
determining, based on the initial coordinates and the gray levels of the initial temperature-sensitive phosphorescent particles, the motion trajectory and the gray-level change of the target temperature-sensitive phosphorescent particle.

In a possible implementation of the first aspect, the determining, based on the initial coordinates and the gray levels of the initial temperature-sensitive phosphorescent particles, the motion trajectory and the gray-level change of the target temperature-sensitive phosphorescent particle includes:
performing screening for the initial temperature-sensitive phosphorescent particles based on the gray levels of the initial temperature-sensitive phosphorescent particles and a preset gray-level threshold, to obtain initial target temperature-sensitive phosphorescent particles, where the preset gray-level threshold is determined based on a type of the initial temperature-sensitive phosphorescent particles;
performing fitting processing on initial coordinates and gray levels of the initial target temperature-sensitive phosphorescent particles based on a two-dimensional Gaussian template, to obtain sub-pixel coordinates of the initial target temperature-sensitive phosphorescent particles;
determining, based on the sub-pixel coordinates of the initial target temperature-sensitive phosphorescent particles, a motion trajectory of the target temperature-sensitive phosphorescent particle; and
determining the gray-level change of the target temperature-sensitive phosphorescent particle based on the gray levels of the initial target temperature-sensitive phosphorescent particles.

In a possible implementation of the first aspect, the determining, based on the sub-pixel coordinates of the initial target temperature-sensitive phosphorescent particles, a motion trajectory of the target temperature-sensitive phosphorescent particle includes:
determining sub-pixel coordinates of an initial target temperature-sensitive phosphorescent particle in a first initial target timing frame image to a fourth initial target timing frame image, where the first initial target timing frame image to the fourth initial target timing frame image are four image frames that are adjacent in time sequence;
determining an initial motion trajectory of the initial target temperature-sensitive phosphorescent particle based on the sub-pixel coordinates of the initial target temperature-sensitive phosphorescent particle in the first initial target timing frame image to the fourth initial target timing frame image;
determining a velocity of the initial target temperature-sensitive phosphorescent particle based on the initial motion trajectory of the initial target temperature-sensitive phosphorescent particle;
performing, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle;
determining acceleration of the target temperature-sensitive phosphorescent particle based on sub-pixel coordinates of the target temperature-sensitive phosphorescent particle in the first initial target timing frame image to the fourth initial target timing frame image; and
obtaining the motion trajectory of the target temperature-sensitive phosphorescent particle based on the velocity and the acceleration of the target temperature-sensitive phosphorescent particle.

In a possible implementation of the first aspect, the determining sub-pixel coordinates of an initial target temperature-sensitive phosphorescent particle in a first initial target timing frame image to a fourth initial target timing frame image includes:
determining the sub-pixel coordinates and corresponding neighboring particles of the initial target temperature-sensitive phosphorescent particle in the first initial target timing frame image, and first coordinate positions of the neighboring particles, where the neighboring particles represent particles within a preset distance from the initial target temperature-sensitive phosphorescent particle;
determining second coordinate positions of the neighboring particles in a second initial target timing frame image based on the initial target temperature-sensitive phosphorescent particle and the neighboring particles;
determining a target displacement based on the first coordinate positions and the second coordinate positions; and
determining sub-pixel coordinates of the initial target temperature-sensitive phosphorescent particle in a third initial target timing frame image and the fourth initial target timing frame image based on the sub-pixel coordinates of the initial target temperature-sensitive phosphorescent particle in the first initial target timing frame image and the target displacement.

In a possible implementation of the first aspect, the performing, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle includes:
determining velocities of the neighboring particles of the initial target temperature-sensitive phosphorescent particle;
determining a velocity range and a velocity-range median value of the neighboring particles based on the velocities of the neighboring particles;
determining a velocity residual range and a velocity-residual-range median value of the neighboring particles based on the velocities and the velocity-range median value of the neighboring particles;
determining a velocity residual of the initial target temperature-sensitive phosphorescent particle based on the velocities, the velocity-range median value, and the velocity-residual-range median value of the neighboring particles; and
performing screening for the initial target temperature-sensitive phosphorescent particles based on velocity residuals of the initial target temperature-sensitive phosphorescent particles and a preset velocity residual threshold, to determine the target temperature-sensitive phosphorescent particle from the initial target temperature-sensitive phosphorescent particles and the velocity of the target temperature-sensitive phosphorescent particle.

In a possible implementation of the first aspect, the determining a decay-slope constant of the target temperature-sensitive phosphorescent particle based on the gray-level change of the target temperature-sensitive phosphorescent particle in the particle timing frame image includes:
determining a gray level of the target temperature-sensitive phosphorescent particle in a target particle timing frame image; and
determining a luminescence lifetime and the decay-slope constant of the target temperature-sensitive phosphorescent particle based on a relationship between an emission intensity of the target temperature-sensitive phosphorescent particle and a time, and the gray level of the target temperature-sensitive phosphorescent particle in the target particle timing frame image and a corresponding target moment.

In a possible implementation of the first aspect, the determining a temperature of the target temperature-sensitive phosphorescent particle based on the decay-slope constant of the target temperature-sensitive phosphorescent particle and a preset correspondence includes:
determining a fitting relationship between a flow-field temperature under a standard condition and a corresponding decay-slope constant; and
determining the temperature of the target temperature-sensitive phosphorescent particle based on the decay-slope constant of the target temperature-sensitive phosphorescent particle and the fitting relationship between the flow-field temperature under the standard condition and the corresponding decay-slope constant.

In a second aspect, the present application provides an apparatus for simultaneous measurement of flow-field velocity and temperature. The apparatus includes:
a first determining module configured to determine a motion trajectory and a gray-level change of a target temperature-sensitive phosphorescent particle in particle timing frame images, where the particle timing frame images are images obtained by performing continuous multi-frame sampling for a phosphorescence decay process of the target temperature-sensitive phosphorescent particle in a flow field to be measured;
a second determining module configured to determine a velocity of the target temperature-sensitive phosphorescent particle based on the motion trajectory of the target temperature-sensitive phosphorescent particle in the particle timing frame images;
a third determining module configured to determine a decay-slope constant of the target temperature-sensitive phosphorescent particle based on the gray-level change of the target temperature-sensitive phosphorescent particle in the particle timing frame images;
a fourth determining module configured to determine a temperature of the target temperature-sensitive phosphorescent particle based on the decay-slope constant of the target temperature-sensitive phosphorescent particle and a preset correspondence, where the correspondence represents a correspondence between a decay-slope constant and a temperature of a temperature-sensitive phosphorescent particle; and
a fifth determining module configured to determine a velocity and a temperature of the flow field to be measured based on the velocity of the target temperature-sensitive phosphorescent particle and the temperature of the target temperature-sensitive phosphorescent particle.

In a third aspect, the present application provides a non-transitory computer-readable storage medium storing computer-executable instructions that, when executed by a processor, cause the first aspect and/or various possible implementations of the first aspect to be implemented.

According to the method and apparatus for simultaneous measurement of flow-field velocity and temperature, and storage medium provided in the present application, the continuous multi-frame sampling is performed for the phosphorescence emitted by the temperature-sensitive phosphorescent particles in the flow field and the motion trajectory of the temperature-sensitive phosphorescent particle in the particle timing frame images is tracked, so that the particle velocity can be obtained while accurately obtaining the gray level of the particle in motion and its gray-level decay process. Based on the gray-level change of the particle, the decay-slope constant of the temperature-sensitive phosphorescent particle is calculated, so that the temperature of the temperature-sensitive phosphorescent particle is obtained based on the correspondence between the decay-slope constant and the temperature of the temperature-sensitive phosphorescent particle. Since the temperature-sensitive phosphorescent particles have good velocity followability and temperature followability, the velocity and temperature of the phosphorescent particle can be used to represent the velocity and temperature of the position at which the particle is located in the flow field at that moment, thereby realizing simultaneous measurement of the flow-field velocity and temperature.

### BRIEF DESCRIPTION OF THE DRAWINGS

The accompanying drawings herein, which are incorporated into and form a part of the description, illustrate the embodiments in line with the present application and are used in conjunction with the description to explain the principles of the present application.

FIG. 1 is a schematic diagram of an application scenario of a method for simultaneous measurement of flow-field velocity and temperature according to an embodiment of the present application;

FIG. 2 is a first flowchart of a method for simultaneous measurement of flow-field velocity and temperature according to an embodiment of the present application;

FIG. 3 a diagram of a calibration curve of temperature versus decay slope constant according to an embodiment of the present application;

FIG. 4 is a second flowchart of a method for simultaneous measurement of flow-field velocity and temperature according to an embodiment of the present application;

FIG. 5 is a sequence diagram of flow-field velocity and temperature simultaneous measurement according to an embodiment of the present application;

FIG. 6 is a third flowchart of a method for simultaneous measurement of flow-field velocity and temperature according to an embodiment of the present application;

FIG. 7 is a fourth flowchart of a method for simultaneous measurement of flow-field velocity and temperature according to an embodiment of the present application;

FIG. 8A-8B are diagrams of simultaneous measurement results of a cold-jet velocity field and temperature field according to an embodiment of the present application; and

FIG. 9 is a schematic diagram of a structure of an apparatus for simultaneous measurement of flow-field velocity and temperature according to an embodiment of the present application.

Explicit embodiments of the present application have been shown by means of the above-mentioned drawings and will be described in more detail below. These drawings and textual descriptions are not intended to limit the scope of the concept of the present application in any way, but rather to illustrate the concept of the present application to those skilled in the art with reference to specific embodiments.

### DETAILED DESCRIPTION OF THE EMBODIMENTS

Exemplary embodiments are described in detail herein, and examples thereof are illustrated in the accompanying drawings. When the following description relates to the accompanying drawings, the same numerals in different accompanying drawings denote the same or similar elements, unless otherwise indicated. The implementations described in the following exemplary embodiments do not represent all the implementations consistent with the present application. Rather, they are merely examples of apparatuses and methods that are consistent with some aspects of the present application and that are described in detail in the appended claims.

First, an explanation of the nouns involved in the present application is given.

A temperature-sensitive phosphorescent particle: it is a phosphorescent particle with a temperature-responsive property, and is composed of a solid-crystal material doped with rare-earth or transition-metal ions. It can emit phosphorescence after being acted upon by excitation light of a specific wavelength, and its phosphorescence signal characteristics such as a luminescence lifetime, an emission wavelength, and a luminous intensity will change with a temperature.

A flow field: it refers to a flow state and distribution of liquid or gas in a space.

At present, individual flow-field velocity measurement and temperature measurement means are relatively mature. However, technologies for simultaneous measurement of flow-field velocity and temperature are still in the development stage. In the existing technology, distribution of velocities of a single point in fluid flow is generally measured using devices such as hot-wire or laser Doppler velocimetry, while temperatures at various points in the fluid flow are measured using methods such as thermocouples or laser-induced fluorescence. However, these velocity and temperature measurement methods cannot be easily combined to achieve simultaneous measurement of a flow-field velocity and temperature. Among the existing simultaneous measurement techniques, a two-dimensional probe method is an invasive measurement method that can measure just limited discrete points and is prone to interfere with a flow field. For a three-dimensional flow-field velocity and temperature measurement method based on a light-field camera, a cross-correlation technique is used, which results in low spatial resolution of velocity measurement, and a problem of particle tailing caused by a long image exposure time will result in a small velocity measurement range and large errors in velocity and temperature measurement.

According to the method for simultaneous measurement of flow-field velocity and temperature provided in the present application, simultaneous measurement of a flow-field velocity and temperature is realized by dispersing phosphorescent particles, whose decay lifetimes decrease with increasing temperature, into the flow field as tracer particles, in combination with a particle tracking velocimetry technique and a phosphorescence-lifetime-decay-based thermal imaging temperature measurement technique based on multiple particle image frames. This method is non-contact, has no interference with the flow field, and can achieve instantaneous planar measurement of a velocity field and a temperature field. At the same time, a particle tracking velocimetry method is used to perform velocity field measurement, and the flow-field velocity is obtained by tracking a motion trajectory of a single particle in multiple image frames, which can achieve sub-pixel level spatial resolution of measurement, thus improving the measurement resolution. Due to continuous multi-frame sampling, a phosphorescence decay process of each particle can be tracked, so that a decay lifetime of the phosphorescent particle can be calculated using multiple particle image frames. Thus the image exposure time is short, which avoids the influence of particle tailing, and a number of fitting points is larger, which can effectively reduce the effects of noise, so that the method offers a larger velocity measurement range and higher measurement accuracy.

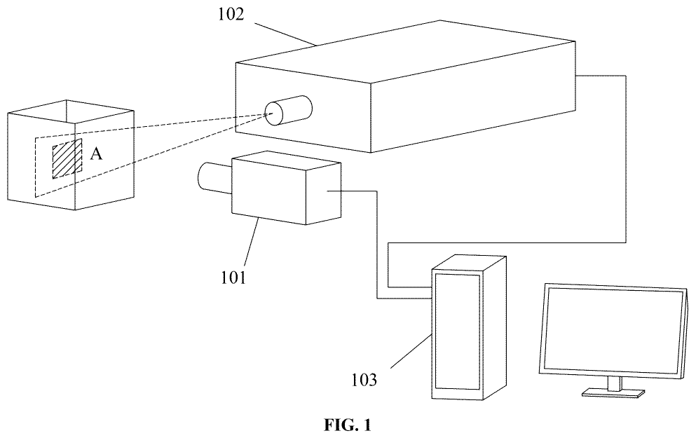

FIG. 1 is a schematic diagram of an application scenario of a method for simultaneous measurement of the flow-field velocity and temperature according to an embodiment of the present application. As shown in FIG. 1, an application scenario of the solution provided in the present application includes a high-speed camera 101, an ultraviolet laser 102, and a control host 103.

The control host 103 may send control signals to the high-speed camera 101 and the ultraviolet laser 102 at the same time. After receiving a control signal, the ultraviolet laser 102 emits a laser pulse, which can instantly illuminate a flow field area A to be measured. After being excited, phosphorescent particles in the flow field area A to be measured emit phosphorescence. The high-speed camera 101 focuses on the area A to be measured. After receiving a control signal from the control host 103, the high-speed camera 101 starts to acquire a luminescence process of the phosphorescent particles. On a camera lens, a bandpass filter is mounted to filter out stray light of other wavelengths. After acquisition is completed, the high-speed camera 101 transmits images to the control host 103, and the control host 103 completes subsequent image processing work.

Although there is just one high-speed camera 101, laser 102, and control host 103 shown in FIG. 1, it should be understood that there may be two or more high-speed cameras 101, lasers 102, and control hosts 103.

The technical solutions of the present application and how the technical solutions of the present application solve the above technical problem are described below in detail with specific embodiments. The following several specific embodiments may be combined with each other, and details about same or similar concepts or processes may not be described in some embodiments again. The embodiments of the present application are described below with reference to the accompanying drawings.

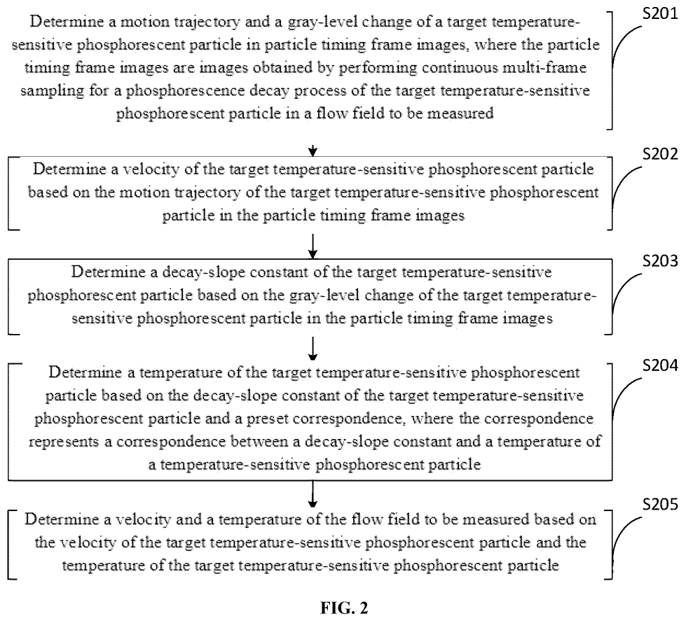

FIG. 2 is the first flowchart of a method for simultaneous measurement of the flow-field velocity and temperature according to an embodiment of the present application.

As shown in FIG. 2, the method may include steps S201-S205.

In step S201, a motion trajectory and a gray-level change of a target temperature-sensitive phosphorescent particle in particle timing frame images are determined, where the particle timing frame images are images obtained by performing continuous multi-frame sampling for a phosphorescence decay process of the target temperature-sensitive phosphorescent particle in a flow field to be measured.

The target temperature-sensitive phosphorescent particle may be temperature-sensitive phosphorescent particles with the gray level and the velocity both meeting a threshold requirement, which are obtained by screening for phosphorescent particles with a temperature-sensitive effect that are uniformly dispersed at a certain concentration in the flow field to be measured and then acquired by a high-speed camera, where the phosphorescent particles with a temperature-sensitive effect dispersed in the flow field to be measured are initial temperature-sensitive phosphorescent particles.

The particle timing frame images may contain initial particle timing frame images, initial target timing frame images, and target particle timing frame images. In the particle timing frame images, each image represents positions and states of particles at a moment. Information such as a motion trajectory and a distribution of velocities and gray levels of the particles can be observed through a continuous image sequence. The initial particle timing frame images are image sequence captured by the high-speed camera at different time points in a particle luminescence process, the initial target timing frame images are a particle image sequence obtained by performing screening for particles in the initial particle timing frame images based on a gray-level threshold, and the target particle timing frame images are a particle image sequence obtained by performing screening for particles in the initial target timing frame images based on a velocity. Since the high-speed camera has a high frame rate, it can shoot videos or continuous images at hundreds or even thousands of frames per second Thus, in an embodiment of the present application, the high-speed camera is used to capture temperature-sensitive phosphorescent particle images over one period, corresponding to a flow field at a moment, and then the particle images are processed using a lifetime decay method and a tracking velocimetry technique, so that a velocity field and temperature field at a same moment may be obtained.

The motion trajectory may be a path or trajectory depicted by an object during its motion, describing a law governing the change of a position of the object in space over time. A motion trajectory of the particle may be obtained through a particle matching algorithm, including a nearest neighbor matching algorithm, a regression-based multi-frame tracking algorithm, a relaxation algorithm, a Thiessen polygon matching algorithm, a neural network algorithm, etc. A computer algorithm that matches particles or targets in two or more image sequences is used to track positions, velocities, trajectories, and other information of particles between different frames, enabling analysis and monitoring of particle motion. In the embodiment of the present application, since the temperature-sensitive phosphorescent particles have good velocity followability and temperature followability, after the phosphorescent particles are excited by laser to emit phosphorescence, the high-speed camera may be used to perform continuous multi-frame sampling for phosphorescence decay processes of the phosphorescent particles, and a motion trajectory and a gray-level change of each phosphorescent particle in multiple image frames may be tracked to obtain a velocity and temperature of the particle, so that the velocity and temperature of the phosphorescent particle is used to represent a velocity and temperature of a position at which the particle is located in the flow field at that moment.

The gray-level change may be a change in a gray-level value of the phosphorescent particle displayed in multiple image frames shot by the high-speed camera. A gray-level value of the phosphorescent particle is usually related to an intensity of phosphorescence it emits. A brighter phosphorescent particle is displayed at a higher gray-level value in an image, while a darker phosphorescent particle is displayed at a lower gray-level value. By performing analysis and processing on the gray-level of the phosphorescent particles, a number, a distribution, and other information of phosphorescent particles in a sample may be quantitatively evaluated. A distribution of gray levels of the particles may be obtained through a particle identification algorithm, including a threshold segmentation algorithm, an edge detection algorithm, a morphological processing algorithm, a feature extraction algorithm, and a machine learning algorithm. Based on specific application requirements and image features, a particle or target object in an image or a video may be automatically detected and identified to achieve accurate identification, quantitative analysis, statistics, tracking, and other applications of the particles. In the embodiment of the present application, using a phosphorescent thermal imaging temperature measurement technique based on the lifetime decay method, through shooting the multiple image frames by the high-speed camera to obtain the gray-level change of the particles, and fitting the phosphorescence decay process, a phosphorescence decay lifetime is calculated.

In the embodiment of the present application, the step of determining a motion trajectory and a gray-level change of a target temperature-sensitive phosphorescent particle in particle timing frame images may include:
performing enhancement processing on an initial particle timing frame image to obtain a first initial particle timing frame image;
performing dilation processing on the first initial particle timing frame image to obtain a second initial particle timing frame image;
comparing the first initial particle timing frame image with the second initial particle timing frame image to determine initial coordinates and gray levels of initial temperature-sensitive phosphorescent particles; and
determining, based on the initial coordinates and the gray levels of the initial temperature-sensitive phosphorescent particles, the motion trajectory and the gray-level change of the target temperature-sensitive phosphorescent particle.

The initial particle timing frame images may be original timing frame images shot by the high-speed camera. The target particle timing frame images are obtained by processing the initial particle timing frame images and performing screening based on gray levels and velocities of the particles, and the target particle timing frame images are standard timing frame images.

The enhancement processing may refer to processing of an image through Gaussian Laplacian filter to smooth the image on the basis of reducing effects of noise, so that outlines and edges of particles in the image are enhanced, which is conducive to improving accuracy of particle-center coordinate identification and sub-pixel coordinate fitting. In the embodiment of the present application, gray-level values of the images may be processed by the Gaussian Laplacian filter to highlight contours of the particles in the images and obtain the first initial particle timing frame images.

Details of a process of the Gaussian Laplacian filter are as steps 1)-3).

In step 1), first, a two-dimensional square grid centered at 0 is generated. A size of the grid is usually the smallest odd number greater than twice a particle size. The particle size is affected by an actual shooting condition and may vary from one to more than ten pixels. Phosphorescent particles used in this experiment have a relatively small size, and the particle size is usually taken as 3. Assuming the particle size is 3, a size of a grid matrix is 7×7, that is, values of m and n in grid coordinates (m, n) of the two-dimensional grid are −3, −2, −1, 0, 1, 2, and 3.

In step 2), coordinates (m, n) of the two-dimensional square grid are substituted into a Laplacian of Gaussian operator generation formula, and a Laplacian of Gaussian operator with the same size as the grid is obtained. A calculation formula of a Laplacian of Gaussian operator H is:

$$H ( m , n ) = - \frac{( {m}^{2} + {n}^{2} - 2 {σ}^{2} ) {e}^{\frac{- ( {m}^{2} + {n}^{2} )}{2 {σ}^{2}}}}{{σ}^{4} {\sum }_{m} {\sum }_{n} {e}^{\frac{- ( {m}^{2} + {n}^{2} )}{2 {σ}^{2}}}}$$

where σ is a standard deviation of a Gaussian distribution, and its value is taken as the particle size; and m and n are grid coordinates.

In step 3), the Laplacian of Gaussian operator is used to perform filtering on a particle image. A specific method is as follows: For a pixel with coordinates (cx, cy) in the image, its gray-level value I(cx, cy) is substituted into the following filtering formula for calculation:

$${I}^{*} = {\sum }_{m} {\sum }_{n} I ( cx + m , cy + n ) H ( m , n )$$

Then I* calculated is used to replace an original gray-level value I of the pixel. By traversing all pixels on the image with the process, a Gaussian Laplacian filter operation on the entire image is completed, that is, processing of a gray-level value of each pixel on the image is completed.

The dilation processing may refer to dilation processing of a binary image or a grayscale image through an imdilate function. A structure element (also called a dilation kernel or a dilation template) is used to slide along each pixel position of the image, and if the structure element has an overlapping portion with a pixel area in the image, the pixel position is marked as a target area, and the target area or object in the image is enhanced to obtain an image with an enhanced target area. In the embodiment of the present application, a pixel with a maximum gray level may be expanded to surrounding pixels through the dilation processing to obtain the second initial particle timing frame images.

Specific details of dilation are as steps (1)-(2).

In step (1), first, a square structure element is generated, and its size is the smallest odd number greater than twice a particle size. Assuming that the particle size is 3 pixels, a size of the structure element is 7×7, and the grayscale image is dilated using the structure element.

In step (2), the structure element is slided along each pixel position of the particle image. When a center of the structure element is located at a pixel with coordinates (cx, cy) in the image, for another pixel within a range of the structure element, if its gray-level value is less than a gray-level value I(cx, cy) of the center of the structure element, then I(cx, cy) is used to replace the gray-level value of the pixel; or if its gray-level value is greater than the gray-level value I(cx, cy) of the center of the structural element, no replacement will be performed on the gray-level value of the pixel. When the above process is completed for each pixel in the image, the dilation processing is completed for the entire image. The dilation processing can expand a pixel with a maximum gray level on the particle to surrounding pixels, preventing a single particle from being identified as multiple particles in the subsequent comparison of images.

The initial coordinates of the initial temperature-sensitive phosphorescent particles may refer to that: in a standard pixel coordinate system, an image is divided into discrete pixel units, each of which has integer coordinate values to represent its position; and when images before and after the dilation processing are compared, positions with a same gray level are a position of a pixel with a maximum local gray level, that is, initial coordinates of a particle center, which are integer coordinates. A gray level corresponding to the integer coordinates (a gray-level value of a pixel with a maximum particle gray level) may be a gray-level mean of a local area (for example, a 3×3 pixel area) centered on the integer coordinates, or it may be a peak gray level obtained through Gaussian fitting of a local area (a pixel area greater than or equal to 3×3 is required).

In the embodiment of the present application, the step of determining, based on the initial coordinates and the gray levels of the initial temperature-sensitive phosphorescent particles, the motion trajectory and the gray-level change of the target temperature-sensitive phosphorescent particle may include:
performing screening for the initial temperature-sensitive phosphorescent particles based on the gray levels of the initial temperature-sensitive phosphorescent particles and a preset gray-level threshold, to obtain initial target temperature-sensitive phosphorescent particles, where the preset gray-level threshold is determined based on a type of the initial temperature-sensitive phosphorescent particles;
performing fitting processing on initial coordinates and a gray level of the initial target temperature-sensitive phosphorescent particles based on a two-dimensional Gaussian template, to obtain sub-pixel coordinates of the initial target temperature-sensitive phosphorescent particles;
determining, based on the sub-pixel coordinates of the initial target temperature-sensitive phosphorescent particles, a motion trajectory of the target temperature-sensitive phosphorescent particle; and
determining the gray-level change of the target temperature-sensitive phosphorescent particle based on the gray level of the initial target temperature-sensitive phosphorescent particles.

The preset gray-level threshold may refer to a set gray-level threshold that is used to extract signals of phosphorescent particles, remove background noise, and distinguish the phosphorescent particles from a surrounding background, given that the phosphorescent particles usually have gray-level values higher than those of the surrounding background during phosphorescent imaging. A common gray-level thresholding method includes a global thresholding method, an adaptive thresholding method, and a thresholding method based on statistical methods. In the embodiment of the present application, a fixed gray-level value is set to perform segmentation of an image, identified particles are screened and filtered to retain just particles with gray-level values above a threshold, that is, the initial target temperature-sensitive phosphorescent particles.

The two-dimensional Gaussian template may be a template which is used to determine a center position through nesting, and the shape of which is similar with a distribution of gray levels of particles in captured particle timing frame images, and the distribution of gray levels is Gaussian-shaped, with high values in the middle and low values at the edges.

The fitting processing may refer to that the template are moved on a plane, when the template and the distribution of gray levels of the particles has a maximum correlation, they are considered to be fitted, and at this case a center position of a highest point of the template is considered to be a center position of the particles. Through the fitting processing, the integer coordinates of the particles obtained in the previous step, that is, the initial coordinates of the particle center, may be refined into sub-pixel coordinates. The sub-pixel coordinates are usually expressed in a floating-point form and may contain a decimal part, which is used to represent a more precise position between pixels. Therefore, by performing fitting processing on all particle images, the specific coordinate positions and corresponding gray levels of the particles on all images may be obtained.

In the embodiment of the present application, the step of determining, based on the sub-pixel coordinates of the initial target temperature-sensitive phosphorescent particles, a motion trajectory of the target temperature-sensitive phosphorescent particle may include:
determining sub-pixel coordinates of each initial target temperature-sensitive phosphorescent particle in a first initial target timing frame image to a fourth initial target timing frame image, where the first initial target timing frame image to the fourth initial target timing frame image are four image frames that are adjacent in time sequence;
determining an initial motion trajectory of the initial target temperature-sensitive phosphorescent particle based on the sub-pixel coordinates of the initial target temperature-sensitive phosphorescent particle in the first initial target timing frame image to the fourth initial target timing frame image;
determining a velocity of the initial target temperature-sensitive 201 phosphorescent particle based on the initial motion trajectory of the initial target temperature-sensitive phosphorescent particle;
performing, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle;
determining an acceleration of the target temperature-sensitive phosphorescent particle based on sub-pixel coordinates of the target temperature-sensitive phosphorescent particle in the first initial target timing frame image to the fourth initial target timing frame image; and
obtaining the motion trajectory of the target temperature-sensitive phosphorescent particle based on the velocity and the acceleration of the target temperature-sensitive phosphorescent particle.

The first initial target timing frame image to the fourth initial target timing frame image may refer to four continuous and adjacent image frames in the initial target timing frame images, for example a first frame of an image to a fourth frame of an image, a second frame of an image to a fifth frame of an image, and so on.

The initial motion trajectory of the initial target temperature-sensitive phosphorescent particle may refer to a motion trajectory of a temperature-sensitive phosphorescent particle that meets a gray-level threshold requirement, which motion trajectory is obtained by comparing and analyzing a spatial distribution of feature points between two consecutive image frames through double-frame matching to determine a correspondence between them. A double-frame method may be used to perform particle matching on an image with a large particle concentration. In the embodiment of the present application, it is applicable to the first four image frames acquired during the phosphorescence decay process. The four image frames have large gray levels, and have a relatively large number of particles identified. By means of sub-pixel coordinates and a gray level (xᵢ₁, yᵢ₁, Iᵢ₁) of the i^{th} particle in the first initial target timing frame image, sub-pixel coordinates and a gray level (xᵢ₂, yᵢ₂, Iᵢ₂) in the second initial target timing frame image, until sub-pixel coordinates and a gray level (xᵢ₄, yᵢ₄, Iᵢ₄) in the fourth initial target timing frame image, an initial motion trajectory of the particle is determined based on a change of sub-pixel coordinates of the particle.

For determining the velocity of the initial target temperature-sensitive phosphorescent particle, the particle velocity may be preliminarily calculated by dividing a difference in positions of the temperature-sensitive phosphorescent particle in previous and next frames of the initial target timing frame images by a time interval between subsequent frames.

The screening may refer to identification and analysis of data points or observations in a dataset that are significantly different from the rest of the data through outlier detection. An outlier may be identified through a statistical method, distance-based or density-based screening, and a machine learning algorithm. In the embodiment of the present application, the screening is performed on the particles in the image by using a local velocity detection pseudovector to check whether a velocity vector is an outlier.

The target temperature-sensitive phosphorescent particle may be a temperature-sensitive phosphorescent particle that has further passed an outlier detection on the basis that its gray level meets the gray-level threshold requirement.

The motion trajectory of the target temperature-sensitive phosphorescent particle may be obtained by performing trajectory extrapolation on an initial motion trajectory through a four-frame matching algorithm. Since the sub-pixel coordinates of the particle in the first initial target timing frame image to the fourth initial target timing frame image have been obtained in the previous step, a velocity and acceleration of particle motion are calculated through the acquired four consecutive image frames, and sub-pixel coordinates of the particle in the fifth initial target timing frame image are predicted. Then, sub-pixel coordinates of the particle in a sixth initial target timing frame image are predicted through second to fifth initial target timing frame images. Repeating in a same manner, the matching of the particle in multiple image frames is obtained, so that the motion trajectory of the particle is obtained. The four-frame matching algorithm makes full use of the particle information in the first four image frames to perform trajectory extrapolation, and can still achieve efficient and accurate matching when a particle gray level in the particle timing frame decreases with phosphorescence decay.

In the embodiment of the present application, the step of determining sub-pixel coordinates of each initial target temperature-sensitive phosphorescent particle in a first initial target timing frame image to a fourth initial target timing frame image may include:
determining the sub-pixel coordinates and corresponding neighboring particles of the initial target temperature-sensitive phosphorescent particle in the first initial target timing frame image, and first coordinate positions of the neighboring particles, where the neighboring particles represent particles within a preset distance from the initial target temperature-sensitive phosphorescent particle;
determining second coordinate positions of the neighboring particles in a second initial target timing frame image based on the initial target temperature-sensitive phosphorescent particle and the neighboring particles;
determining a target displacement based on the first coordinate positions and the second coordinate positions; and
determining sub-pixel coordinates of the initial target temperature-sensitive phosphorescent particle in a third initial target timing frame image and the fourth initial target timing frame image based on the sub-pixel coordinates of the initial target temperature-sensitive phosphorescent particle in the first initial target timing frame image and the target displacement.

The preset distance may be adjusted based on a concentration of temperature-sensitive phosphorescent particles dispersed in an experiment. A number of neighboring particles is generally 10 to 25, and a search range is generally 25 pixels.

The determining second coordinate positions of the neighboring particles in a second initial target timing frame image may include: for an initial target temperature-sensitive phosphorescent particle P in a first initial target timing frame image A, finding N neighboring particles Ni of the initial target temperature-sensitive phosphorescent particle P, and further, based on a preset search range, traversing each initial target temperature-sensitive phosphorescent particle P and neighboring particle Ni, and if there is a corresponding particle Mi within the search range in a second initial target timing frame image B, calculating distances Δx and Δy between a first coordinate position of the neighboring particle Ni and a second coordinate position of the particle Mi, and then repeating the search step to traverse the initial target temperature-sensitive phosphorescent particle P and all its neighboring particles Ni, so as to obtain several distances Δx and Δy, and plotting a histogram by using the distances, where peak values Δxₘₐₓ and Δyₘₐₓ obtained in the histogram are most likely particle displacement, i.e., the target displacement.

Determining sub-pixel coordinates of the initial target temperature-sensitive phosphorescent particles in a second initial target timing frame image may refer to that: when the initial target temperature-sensitive phosphorescent particle P with a position (x, y) in the first initial target timing frame image A, moves by a target displacement of Δxₘₐₓ and Δyₘₐₓ and reaches a predicted position (x+Δxₘₐₓ, y+Δyₘₐₓ) in the second initial target timing frame image B, a particle closest to the predicted position in the second initial target timing frame image B is a particle that is successfully matched.

In the embodiment of the present application, the step of performing, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle may include:
determining velocities of the neighboring particles of the initial target temperature-sensitive phosphorescent particle;
determining a velocity range and a velocity-range median value of the neighboring particles based on the velocities of the neighboring particles;
determining a velocity residual range and a velocity-residual-range median value of the neighboring particles based on the velocities and the velocity-range median value of the neighboring particles;
determining a velocity residual of the initial target temperature-sensitive phosphorescent particles based on the velocities, the velocity-range median value, and the velocity-residual-range median value of the neighboring particles; and
performing screening for the initial target temperature-sensitive phosphorescent particles based on velocity residuals of the initial target temperature-sensitive phosphorescent particles and a preset velocity residual threshold, to determine the target temperature-sensitive phosphorescent particle from the initial target temperature-sensitive phosphorescent particles and the velocity of the target temperature-sensitive phosphorescent particle.

The velocity residual range of the neighboring particles may be determined as follow: for an initial target temperature-sensitive phosphorescent particle with a velocity of U₀ in the timing frame image, a velocity of its neighboring particle k is Uₖ, and a median value velocity Uₘ of its multiple neighboring particles is first calculated, and then a velocity residual rₖ=|Uₖ−Uₘ| corresponding to each neighboring particle is calculated, so as to obtain the velocity residual range of the neighboring particles, where a median value velocity residual is rₘ.

The determining velocity residuals of the initial target temperature-sensitive phosphorescent particles may refer to calculating normalized velocity residuals by the following formula 1 based on the velocities, the velocity-range median value, and the velocity-residual-range median value of the neighboring particles:

$${r}^{′} = \frac{\vert {U}_{k} - {U}_{m} \vert}{{r}_{m} + ε} , \qquad Formula 1$$

where r′ is the velocity residual of the initial target temperature-sensitive phosphorescent particle; ε is a small quantity used to avoid a denominator being 0; Uₖ is the velocity of the neighboring particle k; Uₘ is the median value in the velocity range of the neighboring particle k; and rₘ is the median value in the velocity residual range of the neighboring particle k.

The screening may refer to performing screening for initial target temperature-sensitive phosphorescent particles with the velocity of U₀ in the timing frame image based on the preset velocity residual threshold. In the embodiment of the present application, the preset velocity residual threshold is 2, and when the velocity residual obtained by the above calculation is less than 2, it is indicated that a detected vector is a normal value. For example, if the velocity U₀ of the initial target temperature-sensitive phosphorescent particle is 2, and the velocities Uₖ of its neighboring particles are 1, 1, 1, 2, 2, 3, 3, and 3, respectively, then the velocity-range median value Uₘ of the neighboring particles is 2. The calculated velocity residuals rₖ of the neighboring particles are 1, 1, 1, 0, 0, 1, 1, and 1, and then the velocity-residual-range median value rₘ of the neighboring particles is 1. The velocity residual r′ of the initial target temperature-sensitive phosphorescent particle calculated according to the above formula is 0, which is less than the velocity residual threshold 2, and therefore the initial target temperature-sensitive phosphorescent particle passes the outlier detection and is the target temperature-sensitive phosphorescent particle.

In step S202, a velocity of the target temperature-sensitive phosphorescent particle is determined based on the motion trajectory of the target temperature-sensitive phosphorescent particle in the particle timing frame images.

The determining of the velocity of the target temperature-sensitive phosphorescent particle may be performed as follows: based on positions of a particle i in adjacent first and second image frames, which are (xᵢ₁, yᵢ₁) and (xᵢ₂, yᵢ₂), respectively, a motion velocity (vᵢₓ, v_{iy}) of the phosphorescent particle i may be obtained according to velocity calculation formulas

$${v}_{ix} = \frac{{x}_{i 2} - {x}_{i 1}}{Δ t} and {v}_{iy} = \frac{{y}_{i 2} - {y}_{i 1}}{Δ t} .$$

In step S203, a decay-slope constant of the target temperature-sensitive phosphorescent particle is determined based on the gray-level change of the target temperature-sensitive phosphorescent particle in the particle timing frame images.

The decay-slope constant may be a reciprocal of a decay lifetime t of the temperature-sensitive phosphorescent particle, that is, a rate of change of a logarithm of a phosphorescence emission intensity ratio. In phosphorescent materials, electrons in an excited state transition from a higher energy level to a lower energy level, emitting photons and forming phosphorescence. The electrons in the excited state gradually return to a ground state over time, and released phosphorescence intensity will gradually decrease over time. This phenomenon is referred as phosphorescence decay. A luminescence lifetime and a decay-slope constant of a phosphorescent particle may be calculated by substituting gray levels of the particle in multiple consecutive image frames into the following formula:

$$I = {I}_{0} {e}^{- t / τ} , \qquad Formula 2$$

where I is an emission intensity of a temperature-sensitive phosphorescent particle. In the embodiment of the present application, by means of shooting the decay process of the particles with the high-speed camera, an emission intensity of a temperature-sensitive phosphorescent particle in a camera image is expressed as a gray-level change; I₀ is an emission intensity of the temperature-sensitive phosphorescent particle after being fully excited; and τ is a phosphorescence decay lifetime related to a temperature. The higher the temperature, the shorter the phosphorescence decay lifetime. t is time.

$$ln ( \frac{{I}_{i 1}}{{I}_{ij}} ) = ln ( \frac{{I}_{0} {e}^{- {t}_{1} / τ}}{{I}_{0} {e}^{- {t}_{j} / τ}} ) = - \frac{1}{τ} ( {t}_{1} - {t}_{j} ) = - λ ( {t}_{1} - {t}_{j} ) , \qquad Formula 3$$

where Iᵢ₁ is an emission intensity of the phosphorescent particle i in the first frame of an image acquired after laser is turned off; Iᵢⱼ is an emission intensity of the phosphorescent particle i in the j^{th} frame of an image; and λ is the decay-slope constant of the temperature-sensitive phosphorescent particle.

In the embodiment of the present application, the step of determining a decay-slope constant of the target temperature-sensitive phosphorescent particle based on the gray-level change of the target temperature-sensitive phosphorescent particle in the particle timing frame image may include:
determining a gray level of the target temperature-sensitive phosphorescent particle in a target particle timing frame image; and
determining a luminescence lifetime and the decay-slope constant of the target temperature-sensitive phosphorescent particle based on a relationship between an emission intensity of the target temperature-sensitive phosphorescent particle and a time, and the gray level of the target temperature-sensitive phosphorescent particle in the target particle timing frame image and a corresponding target moment.

The target moment may refer to a moment at which each frame of an image is acquired after the target temperature-sensitive phosphorescent particle is excited by laser and starts to emit light according to the actual situation of the experiment.

In step S204, a temperature of the target temperature-sensitive phosphorescent particle is determined based on the decay-slope constant of the target temperature-sensitive phosphorescent particle and a preset correspondence, where the correspondence represents a correspondence between a decay-slope constant and a temperature of a temperature-sensitive phosphorescent particle.

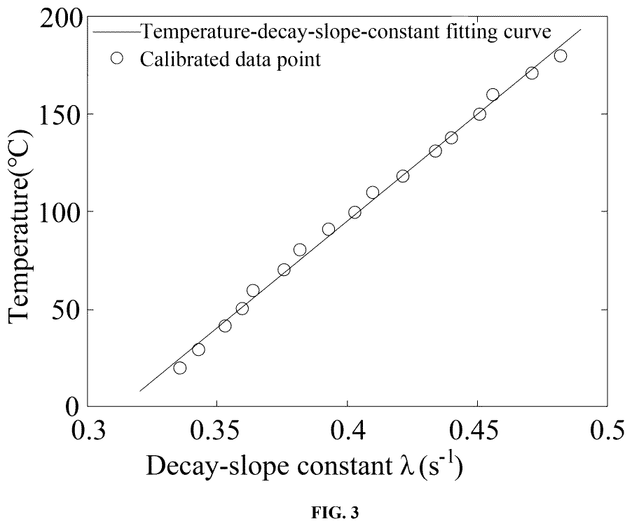

The preset correspondence may be obtained through a calibration experiment in following manner: performing temperature field measurement under a constant temperature condition with a known temperature, calculating a corresponding decay-slope constant, and fitting a set of data points into a curve or function through multiple data points obtained from calibration experiment, so that a temperature-decay-slope-constant schematic diagram is obtained. FIG. 3 is a diagram of a temperature-decay-slope-constant calibration curve according to an embodiment of the present application, where the decay-slope constant is increased as the temperature increases. Therefore, after the decay-slope constant of the temperature-sensitive phosphorescent particle is determined, it may be substituted into the temperature-decay-slope-constant calibration curve to obtain a temperature of the temperature-sensitive phosphorescent particle.

In the embodiment of the present application, the step of determining a temperature of the target temperature-sensitive phosphorescent particle based on the decay-slope constant of the target temperature-sensitive phosphorescent particle and a preset correspondence may include:
determining a fitting relationship between a flow-field temperature under a standard condition and a corresponding decay-slope constant; and
determining the temperature of the target temperature-sensitive phosphorescent particle based on the decay-slope constant of the target temperature-sensitive phosphorescent particle and the fitting relationship between the flow-field temperature under the standard condition and the corresponding decay-slope constant.

In step S205, a velocity and a temperature of the flow field to be measured are determined based on the velocity of the target temperature-sensitive phosphorescent particle and the temperature of the target temperature-sensitive phosphorescent particle.

Based on the above step, the velocity of the temperature-sensitive phosphorescent particle may be obtained. By traversing all particles that are successfully matched on the entire image, a distribution of velocities of an entire measurement area may be obtained. At the same time, a temperature of the temperature-sensitive phosphorescent particle in the flow field at the same moment is obtained. Based on the velocity followability and temperature followability of the temperature-sensitive phosphorescent particles, the velocity and temperature of the phosphorescent particle may be used to represent a velocity and temperature of a position at which the particle is located in the flow field at that moment, thereby determining the flow-field velocity and temperature simultaneously.

In the first flowchart of the method for simultaneous measurement of the flow-field velocity and temperature according to an embodiment of the present application, the continuous multi-frame sampling is performed for the phosphorescence emitted by the temperature-sensitive phosphorescent particles in the flow field and the motion trajectory of the temperature-sensitive phosphorescent particle in the particle timing frame image is tracked, so that the particle velocity can be obtained while accurately obtaining the gray level of the particle in motion and its gray-level decay process. Based on the gray-level change of the particle, the decay-slope constant of the temperature-sensitive phosphorescent particle is calculated, so that the temperature of the temperature-sensitive phosphorescent particle is obtained based on the correspondence between the decay-slope constant and the temperature of the temperature-sensitive phosphorescent particle. Since the temperature-sensitive phosphorescent particles have good velocity followability and temperature followability, the velocity and temperature of the phosphorescent particle can be used to represent the velocity and temperature of the position at which the particle is located in the flow field at that moment, thereby realizing simultaneous measurement of the flow-field velocity and temperature.

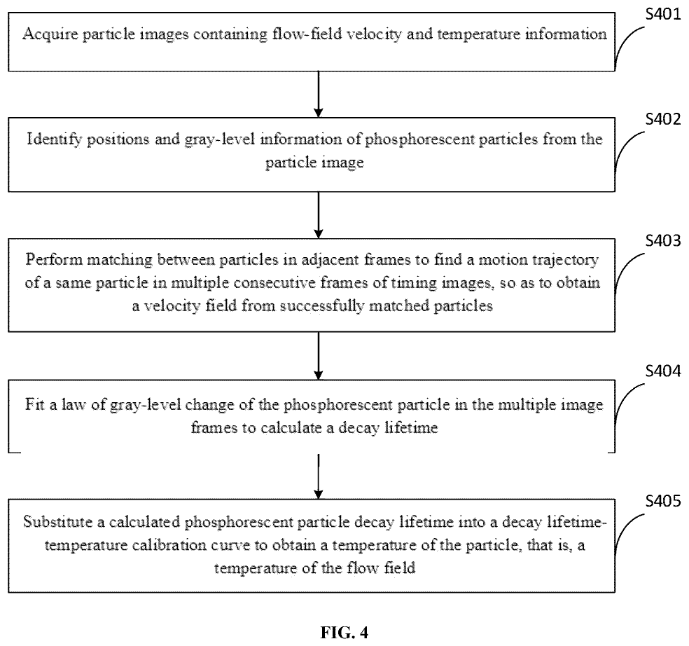

FIG. 4 is the second flow chart of the method for simultaneous measurement of the flow-field velocity and temperature according to an embodiment of the present application.

As shown in FIG. 4, the method may include the steps S401-S405.

In step S401, particle images containing flow-field velocity and temperature information are acquired.

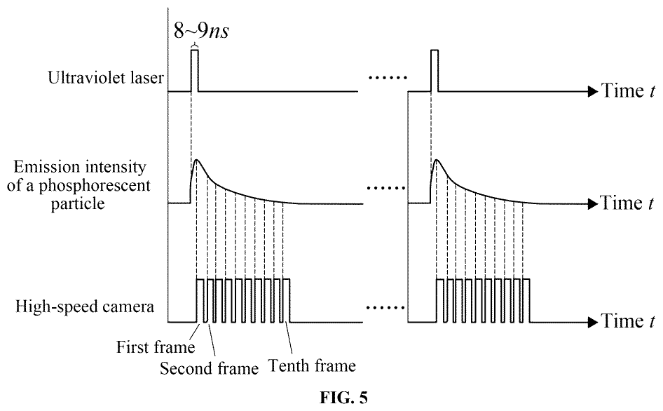

The particle images may be images obtained as follow: evenly dispersing phosphorescent particles with a temperature-sensitive effect in a flow field to be measured at a certain concentration, sending control signals to a high-speed camera and an ultraviolet laser at the same time by means of a control host, so that the laser emits a laser pulse, phosphorescent particles in the flow field area to be measured are excited and emit phosphorescence, while the high-speed camera is focused on the area to be measured to acquire a luminescence process of the phosphorescent particles and obtain the particle image, where pulse duration is about 8˜9 ns, in the form of sheet light with a thickness of 1 mm, which can instantly illuminate the flow field area to be measured. FIG. 5 is a sequence diagram of flow-field velocity and temperature simultaneous measurement according to an embodiment of the present application. The laser emits a laser pulse, the phosphorescent particles are excited and emit phosphorescence, and the high-speed camera continuously shoots multiple image frames (10 frames in the figure). When the laser emits the next pulse, the camera will again continuously shoot multiple image frames.

In step S402, positions and gray-level information of phosphorescent particles are identified from the particle image.

In step S403, matching between particles in adjacent frames is performed to find a motion trajectory of a same particle in multiple consecutive frames of timing images, so as to obtain a velocity field from successfully matched particles while accurately obtaining gray levels of the particles in motion.

In step S404, a law of gray-level change of the phosphorescent particle in the multiple image frames is fitted to calculate a decay lifetime.

In step S405, a calculated phosphorescent particle decay lifetime is substituted into a decay lifetime-temperature calibration curve to obtain a temperature of the particle, that is, a temperature of the flow field.

In the second flowchart of the method for simultaneous measurement of the flow-field velocity and temperature according to an embodiment of the present application, instantaneous measurement and planar measurement of flow-field velocity and temperature may be performed using the non-contact optical measurement method, which avoids interference with the flow field. In addition, the sub-pixel fitting method is used to improve the particle identification accuracy, and the histogram matching and four-frame matching algorithms are used to achieve particle trajectory tracking between multiple image frames, thereby improving the spatial resolution of velocity measurement. At the same time, tracking particle trajectory can obtain the gray levels and their decay processes of the particles in motion, so that the decay life of the phosphorescent particles can be accurately fitted and the effects of noise such as environmental noise and camera background noise can be reduced. At the same time, a shorter exposure time avoids the problem of particle tailing, increasing the velocity measurement range, and improving the velocity and temperature measurement accuracy.

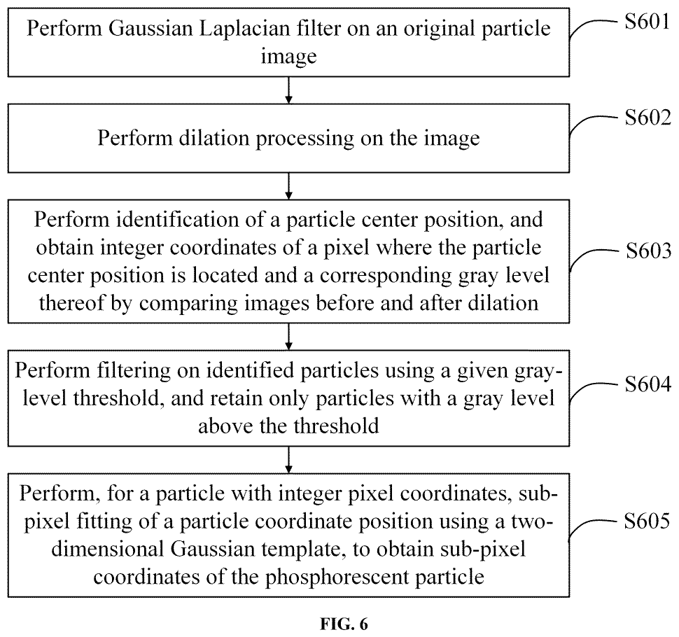

FIG. 6 is the third flowchart of the method for simultaneous measurement of the flow-field velocity and temperature according to an embodiment of the present application.

As shown in FIG. 6, the method may include the steps S601-S605.

In step S601, Gaussian Laplacian filter is performed on an original particle image.

In step S602, dilation processing is performed on the image.

In step S603, identification of a particle center position is performed, and integer coordinates of a pixel where the particle center position is located and a corresponding gray level thereof are obtained by comparing images before and after dilation.

In step S604, filtering is performed on identified particles using a given gray-level threshold, and only particles with a gray level above the threshold are retained.

In step S605, for a particle with integer pixel coordinates, sub-pixel fitting of a particle coordinate position is performed using a two-dimensional Gaussian template, to obtain sub-pixel coordinates of the phosphorescent particle.

In the third flowchart of the method for simultaneous measurement of flow-field velocity and temperature according to an embodiment of the present application, the image processing techniques of the Gaussian Laplacian filter and dilation processing may be combined, and then the sub-pixel fitting method may be used, so as to realize the particle identification process and obtain the accurate particle coordinates, thus improving the accuracy of establishing the particle motion trajectory and the accuracy of velocity and temperature measurement.

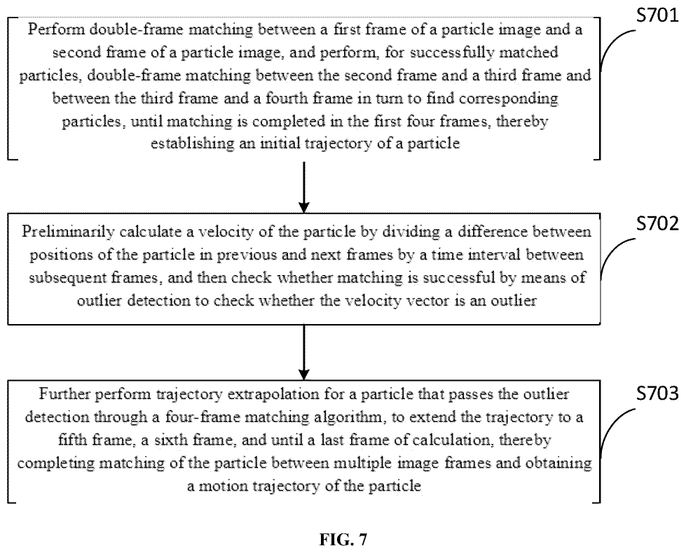

FIG. 7 is a fourth flowchart of the method for simultaneous measurement of the flow-field velocity and temperature according to an embodiment of the present application.

As shown in FIG. 7, the method may include the steps S701-S703.

In step S701, double-frame matching is performed between a first frame of a particle image and a second frame of a particle image, and for successfully matched particles, double-frame matching is performed between the second frame and a third frame and between the third frame and a fourth frame in turn to find corresponding particles, until matching is completed in the first four frames, thereby establishing an initial trajectory of a particle.

In step S702, a velocity of the particle is preliminarily calculated by dividing a difference between positions of the particle in previous and next frames by a time interval between subsequent frames, and then it is checked whether matching is successful by means of outlier detection to check whether the velocity vector is an outlier.

In step S703, further, trajectory extrapolation is performed for a particle that passes the outlier detection through a four-frame matching algorithm, to extend the trajectory to a fifth frame, a sixth frame, and until a last frame of calculation, thereby completing matching of the particle between multiple image frames and obtaining a motion trajectory of the particle.

In the fourth flowchart of the method for simultaneous measurement of the flow-field velocity and temperature according to an embodiment of the present application, particle matching can be performed through the double-frame matching and four-frame matching algorithms, thereby realizing particle trajectory tracking between the multiple image frames with gradually decaying particle gray levels and increasing signal-to-noise ratios, and accurately obtaining the gray levels and their gray-level decay processes of the particles in motion.

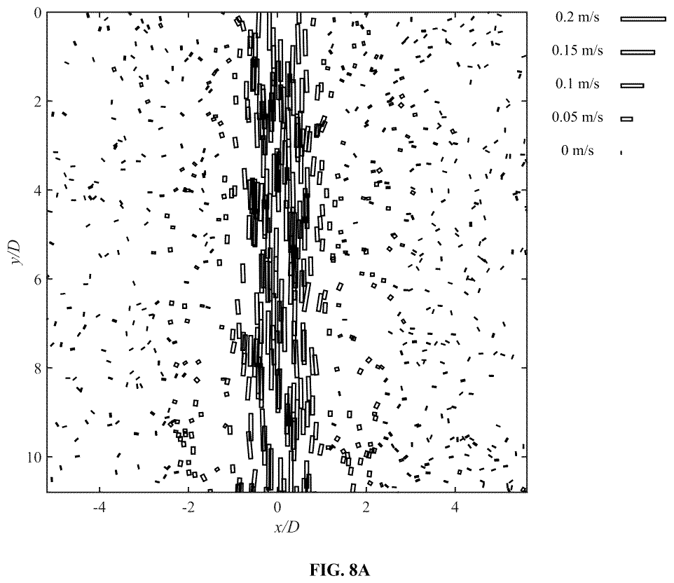

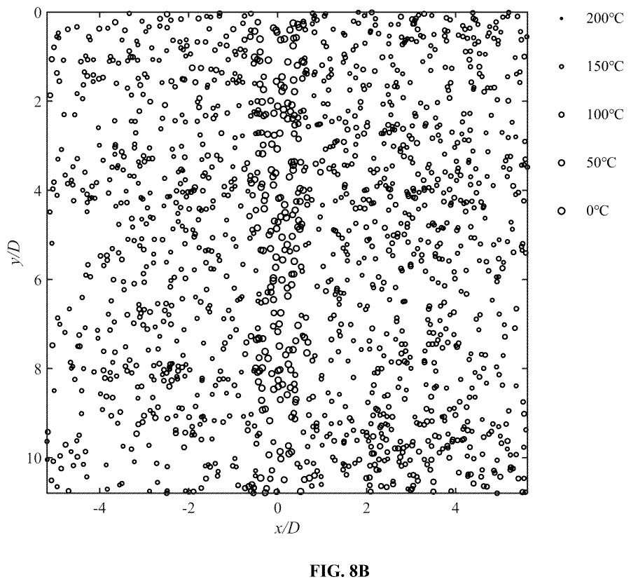

FIG. 8A-8B are diagrams of simultaneous measurement results of a cold-jet velocity field and temperature field according to an embodiment of the present application. When a velocity field and temperature field of a jet-flow field section are measured simultaneously in a 100×100×100 mm transparent quartz cylinder, a temperature in the cylinder is 156° C., a temperature of the jet flow is 31° C., a velocity of the jet flow is about 0.1 m/s, and a nozzle diameter D of the jet flow is 4 mm. Mg₄FGeO₆:Mn phosphorescent particles are used as experimental particles, which can be excited by ultraviolet light to emit red phosphorescence. A peak wavelength of emission is about 655 nm. An exposure time of each frame of a camera is 0.5 milliseconds, and 10 frames are taken each time. The measurement results are shown in FIG. 8A and FIG. 8B, where FIG. 8A is a velocity vector diagram, in which velocities in the jet-flow field section ranges from 0 m/s to 0.2 m/s and boxes of different sizes indicates different velocities, the larger the size of the box is, the higher the velocity is; and FIG. 8B is a temperature field particle diagram, in which temperatures in the jet-flow field section ranges from 0° C. to 200° C. and circles of different sizes indicates different temperatures, the larger the size of the circle is, the higher the temperature is.

It can be seen from the figures that the jet-flow area shows a larger velocity and a lower temperature, while the other regions show smaller velocities and higher temperatures. The measurement results prove that the present disclosure has good capability of velocity and temperature simultaneous measurement.

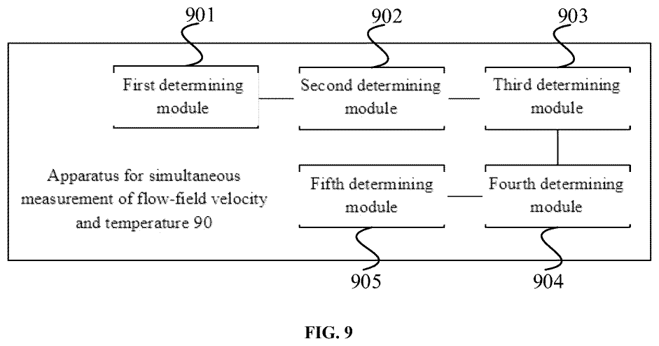

FIG. 9 is a schematic diagram of an apparatus for simultaneous measurement of flow-field velocity and temperature according to an embodiment of the present application. As shown in FIG. 9, the apparatus for simultaneous measurement of flow-field velocity and temperature 90 includes: a first determining module 901, a second determining module 902, a third determining module 903, a fourth determining module 904, and a fifth determining module 905.

The first determining module 901 is configured to determine a motion trajectory and a gray-level change of a target temperature-sensitive phosphorescent particle in particle timing frame images, where the particle timing frame images are images obtained by performing continuous multi-frame sampling for a phosphorescence decay process of the target temperature-sensitive phosphorescent particle in a flow field to be measured.

The second determining module 902 is configured to determine a velocity of the target temperature-sensitive phosphorescent particle based on the motion trajectory of the target temperature-sensitive phosphorescent particle in the particle timing frame images.

The third determining module 903 is configured to determine a decay-slope constant of the target temperature-sensitive phosphorescent particle based on the gray-level change of the target temperature-sensitive phosphorescent particle in the particle timing frame images.

The fourth determining module 904 is configured to determine a temperature of the target temperature-sensitive phosphorescent particle based on the decay-slope constant of the target temperature-sensitive phosphorescent particle and a preset correspondence, where the correspondence represents a correspondence between a decay-slope constant and a temperature of a temperature-sensitive phosphorescent particle.

The fifth determining module 905 is configured to determine a velocity and a temperature of the flow field to be measured based on the velocity of the target temperature-sensitive phosphorescent particle and the temperature of the target temperature-sensitive phosphorescent particle.

In an embodiment of the present application, the first determining module 901 may further be specifically configured to:
perform enhancement processing on an initial particle timing frame image to obtain a first initial particle timing frame image;
perform dilation processing on the first initial particle timing frame image to obtain a second initial particle timing frame image;
compare the first initial particle timing frame image with the second initial particle timing frame image to determine initial coordinates and gray levels of initial temperature-sensitive phosphorescent particles; and
determine, based on the initial coordinates and the gray levels of the initial temperature-sensitive phosphorescent particles, the motion trajectory and the gray-level change of the target temperature-sensitive phosphorescent particle.

In an embodiment of the present application, the first determining module 901 may further be specifically configured to:
perform screening for the initial temperature-sensitive phosphorescent particles based on the gray levels of the initial temperature-sensitive phosphorescent particles and a preset gray-level threshold, to obtain initial target temperature-sensitive phosphorescent particles, where the preset gray-level threshold is determined based on a type of the initial temperature-sensitive phosphorescent particles;
perform fitting processing on initial coordinates and gray levels of the initial target temperature-sensitive phosphorescent particles based on a two-dimensional Gaussian template, to obtain sub-pixel coordinates of the initial target temperature-sensitive phosphorescent particles;
determine, based on the sub-pixel coordinates of the initial target temperature-sensitive phosphorescent particles, a motion trajectory of the target temperature-sensitive phosphorescent particle; and
determine the gray-level change of the target temperature-sensitive phosphorescent particle based on the gray levels of the initial target temperature-sensitive phosphorescent particles.

In an embodiment of the present application, the first determining module 901 may further be specifically configured to:
determine sub-pixel coordinates of an initial target temperature-sensitive phosphorescent particle in a first initial target timing frame image to a fourth initial target timing frame image, where the first initial target timing frame image to the fourth initial target timing frame image are four image frames that are adjacent in time sequence;
determine an initial motion trajectory of the initial target temperature-sensitive phosphorescent particle based on the sub-pixel coordinates of the initial target temperature-sensitive phosphorescent particle in the first initial target timing frame image to the fourth initial target timing frame image;
determine a velocity of the initial target temperature-sensitive phosphorescent particle based on the initial motion trajectory of the initial target temperature-sensitive phosphorescent particle;
perform, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle;
determine acceleration of the target temperature-sensitive phosphorescent particle based on sub-pixel coordinates of the target temperature-sensitive phosphorescent particle in the first initial target timing frame image to the fourth initial target timing frame image; and
obtain the motion trajectory of the target temperature-sensitive phosphorescent particle based on the velocity and the acceleration of the target temperature-sensitive phosphorescent particle.

In an embodiment of the present application, the first determining module 901 may further be specifically configured to:
determine the sub-pixel coordinates and corresponding neighboring particles of the initial target temperature-sensitive phosphorescent particle in the first initial target timing frame image, and first coordinate positions of the neighboring particles, where the neighboring particles represent particles within a preset distance from the initial target temperature-sensitive phosphorescent particle;
determine second coordinate positions of the neighboring particles in a second initial target timing frame image based on the initial target temperature-sensitive phosphorescent particle and the neighboring particles;
determine a target displacement based on the first coordinate positions and the second coordinate positions; and
determine sub-pixel coordinates of the initial target temperature-sensitive phosphorescent particle in a third initial target timing frame image and the fourth initial target timing frame image based on the sub-pixel coordinates of the initial target temperature-sensitive phosphorescent particle in the first initial target timing frame image and the target displacement.

In an embodiment of the present application, the first determining module 901 may further be specifically configured to:
determine velocities of the neighboring particles of the initial target temperature-sensitive phosphorescent particle;
determine a velocity range and a velocity-range median value of the neighboring particles based on the velocities of the neighboring particles;
determine a velocity residual range and a velocity-residual-range median value of the neighboring particles based on the velocities and the velocity-range median value of the neighboring particles;
determine a velocity residual of the initial target temperature-sensitive phosphorescent particle based on the velocities, the velocity-range median value, and the velocity-residual-range median value of the neighboring particles; and
perform screening for the initial target temperature-sensitive phosphorescent particles based on velocity residuals of the initial target temperature-sensitive phosphorescent particles and a preset velocity residual threshold, to determine the target temperature-sensitive phosphorescent particle from the initial target temperature-sensitive phosphorescent particles and the velocity of the target temperature-sensitive phosphorescent particle.

In an embodiment of the present application, the third determining module 903 may further be specifically configured to:
determine a gray level of the target temperature-sensitive phosphorescent particle in a target particle timing frame image; and
determine a luminescence lifetime and the decay-slope constant of the target temperature-sensitive phosphorescent particle based on a relationship between an emission intensity of the target temperature-sensitive phosphorescent particle and a time, and the gray level of the target temperature-sensitive phosphorescent particle in the target particle timing frame image and a corresponding target moment.

In an embodiment of the present application, the fourth determining module 904 may further be specifically configured to:
determine a fitting relationship between a flow-field temperature under a standard condition and a corresponding decay-slope constant; and
determine the temperature of the target temperature-sensitive phosphorescent particle based on the decay-slope constant of the target temperature-sensitive phosphorescent particle and the fitting relationship between the flow-field temperature under the standard condition and the corresponding decay-slope constant.

The apparatus for simultaneous measurement of flow-field velocity and temperature 90 provided in this embodiment of the present application may be configured to perform the above method embodiments. For the specific implementation principle and technical effects thereof, reference may be made to the method embodiments, and they are not described herein again in this embodiment.

A person of ordinary skill in the art will appreciate that all or some of the steps in the various methods of the above embodiments may be completed by instructions, or by controlling related hardware through the instructions. The instructions may be stored in a computer-readable storage medium and loaded and executed by a processor.

To this end, an embodiment of the present application provides a computer-readable storage medium storing multiple instructions, where the instructions can be loaded by a processor to execute the steps in any one of the flow-field velocity and temperature simultaneous measurement methods provided in the embodiments of the present application.

The storage medium may include: a read only memory (ROM), a random access memory (RAM), a disk drive or an optical discs, etc.

According to an aspect of the present application, a computer program product or a computer program is provided. The computer program product or the computer program includes computer-executable instructions. The computer-executable instructions are stored in a computer-readable storage medium.

Since the instructions stored in the storage medium can execute the steps in any one of the methods for simultaneous measurement of flow-field velocity and temperature provided in the embodiments of the present application, the beneficial effects that can be achieved by any one of the methods for simultaneous measurement of flow-field velocity and temperature provided in the embodiments of the present application can be achieved. For details, reference may be made to the previous embodiments, which will not be repeated here.

Persons skilled in the art may readily figure out other implementation solutions of the present application after considering the specification and practicing the invention disclosed herein. The present application is intended to cover any variations, purposes, or adaptive changes of the present application. Such variations, purposes, or applicable changes follow the general principle of the present application and include common knowledge or conventional technical means in the art which is not disclosed in the present application. The specification and embodiments are merely considered as examples, and the true scope and spirit of the present application are defined by the appended claims.

It should be understood that the present application is not limited to the exact structure that has been described above and shown in the accompanying drawings, and various modifications and changes may be made without departing from the scope of the present application. The scope of the present application is defined only by the appended claims.

What is claimed is:

1. A method for simultaneous measurement of flow-field velocity and temperature, comprising:
determining a motion trajectory and a gray-level change of a target temperature-sensitive phosphorescent particle in particle timing frame images, wherein the particle timing frame images are images obtained by performing continuous multi-frame sampling for a phosphorescence decay process of the target temperature-sensitive phosphorescent particle in a flow field to be measured;
determining a velocity of the target temperature-sensitive phosphorescent particle based on the motion trajectory of the target temperature-sensitive phosphorescent particle in the particle timing frame images;
determining a decay-slope constant of the target temperature-sensitive phosphorescent particle based on the gray-level change of the target temperature-sensitive phosphorescent particle in the particle timing frame images;
determining a temperature of the target temperature-sensitive phosphorescent particle based on the decay-slope constant of the target temperature-sensitive phosphorescent particle and a predetermined correspondence, wherein the correspondence represents a correspondence between a decay-slope constant and a temperature of a temperature-sensitive phosphorescent particle; and
determining a velocity and a temperature of the flow field to be measured based on the velocity of the target temperature-sensitive phosphorescent particle and the temperature of the target temperature-sensitive phosphorescent particle.

2. The method of claim 1, wherein the determining a motion trajectory and a gray-level change of a target temperature-sensitive phosphorescent particle in particle timing frame images comprises:
performing enhancement processing on an initial particle timing frame image to obtain a first initial particle timing frame image;
performing dilation processing on the first initial particle timing frame image to obtain a second initial particle timing frame image;
comparing the first initial particle timing frame image with the second initial particle timing frame image to determine initial coordinates and gray levels of initial temperature-sensitive phosphorescent particles; and
determining, based on the initial coordinates and the gray levels of the initial temperature-sensitive phosphorescent particles, the motion trajectory and the gray-level change of the target temperature-sensitive phosphorescent particle.

3. The method of claim 2, wherein the determining, based on the initial coordinates and the gray levels of the initial temperature-sensitive phosphorescent particles, the motion trajectory and the gray-level change of the target temperature-sensitive phosphorescent particle comprises:
performing screening for the initial temperature-sensitive phosphorescent particles based on the gray levels of the initial temperature-sensitive phosphorescent particles and a predetermined gray-level threshold, to obtain initial target temperature-sensitive phosphorescent particles, wherein the predetermined gray-level threshold is determined based on a type of the initial temperature-sensitive phosphorescent particles;
performing fitting processing on initial coordinates and gray levels of the initial target temperature-sensitive phosphorescent particles based on a two-dimensional Gaussian template, to obtain sub-pixel coordinates of the initial target temperature-sensitive phosphorescent particles;
determining, based on the sub-pixel coordinates of the initial target temperature-sensitive phosphorescent particles, a motion trajectory of the target temperature-sensitive phosphorescent particle; and
determining the gray-level change of the target temperature-sensitive phosphorescent particle based on the gray levels of the initial target temperature-sensitive phosphorescent particles.

4. The method of claim 3, wherein the determining, based on the sub-pixel coordinates of the initial target temperature-sensitive phosphorescent particles, a motion trajectory of the target temperature-sensitive phosphorescent particle comprises:
determining sub-pixel coordinates of each initial target temperature-sensitive phosphorescent particle in a first initial target timing frame image to a fourth initial target timing frame image, wherein the first initial target timing frame image to the fourth initial target timing frame image are four image frames that are adjacent in time sequence;
determining an initial motion trajectory of the initial target temperature-sensitive phosphorescent particle based on the sub-pixel coordinates of the initial target temperature-sensitive phosphorescent particle in the first initial target timing frame image to the fourth initial target timing frame image;
determining a velocity of the initial target temperature-sensitive phosphorescent particle based on the initial motion trajectory of the initial target temperature-sensitive phosphorescent particle;
performing, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle;
determining an acceleration of the target temperature-sensitive phosphorescent particle based on sub-pixel coordinates of the target temperature-sensitive phosphorescent particle in the first initial target timing frame image to the fourth initial target timing frame image; and
obtaining the motion trajectory of the target temperature-sensitive phosphorescent particle based on the velocity and the acceleration of the target temperature-sensitive phosphorescent particle.

5. The method of claim 4, wherein the determining sub-pixel coordinates of each initial target temperature-sensitive phosphorescent particle in a first initial target timing frame image to a fourth initial target timing frame image comprises:
determining the sub-pixel coordinates and corresponding neighboring particles of the initial target temperature-sensitive phosphorescent particle in the first initial target timing frame image, and first coordinate positions of the neighboring particles, wherein the neighboring particles represent particles within a preset distance from the initial target temperature-sensitive phosphorescent particle;
determining second coordinate positions of the neighboring particles in a second initial target timing frame image based on the initial target temperature-sensitive phosphorescent particle and the neighboring particles;
determining a target displacement based on the first coordinate positions and the second coordinate positions; and
determining sub-pixel coordinates of the initial target temperature-sensitive phosphorescent particle in a third initial target timing frame image and the fourth initial target timing frame image based on the sub-pixel coordinates of the initial target temperature-sensitive phosphorescent particle in the first initial target timing frame image and the target displacement.

6. The method of claim 4, wherein the performing, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle comprises:
determining velocities of the neighboring particles of the initial target temperature-sensitive phosphorescent particle;
determining a velocity range and a velocity-range median value of the neighboring particles based on the velocities of the neighboring particles;
determining a velocity residual range and a velocity-residual-range median value of the neighboring particles based on the velocities and the velocity-range median value of the neighboring particles;
determining a velocity residual of the initial target temperature-sensitive phosphorescent particle based on the velocities, the velocity-range median value, and the velocity-residual-range median value of the neighboring particles; and
performing screening for the initial target temperature-sensitive phosphorescent particles based on velocity residuals of the initial target temperature-sensitive phosphorescent particles and a predetermined velocity residual threshold, to determine the target temperature-sensitive phosphorescent particle from the initial target temperature-sensitive phosphorescent particles and the velocity of the target temperature-sensitive phosphorescent particle.

7. The method of claim 1, wherein the determining a decay-slope constant of the target temperature-sensitive phosphorescent particle based on the gray-level change of the target temperature-sensitive phosphorescent particle in the particle timing frame image comprises:
determining a gray level of the target temperature-sensitive phosphorescent particle in a target particle timing frame image; and
determining a luminescence lifetime and the decay-slope constant of the target temperature-sensitive phosphorescent particle based on a relationship between an emission intensity of the target temperature-sensitive phosphorescent particle and a time, and the gray level of the target temperature-sensitive phosphorescent particle in the target particle timing frame image and a corresponding target moment.

8. The method of claim 1, wherein the determining a temperature of the target temperature-sensitive phosphorescent particle based on the decay-slope constant of the target temperature-sensitive phosphorescent particle and a predetermined correspondence comprises:
determining a fitting relationship between a flow-field temperature under a standard condition and a corresponding decay-slope constant; and
determining the temperature of the target temperature-sensitive phosphorescent particle based on the decay-slope constant of the target temperature-sensitive phosphorescent particle and the fitting relationship between the flow-field temperature under the standard condition and the corresponding decay-slope constant.

9. An apparatus for simultaneous measurement of flow-field velocity and temperature, wherein the apparatus comprises:
a first determining module configured to determine a motion trajectory and a gray-level change of a target temperature-sensitive phosphorescent particle in particle timing frame images, wherein the particle timing frame images are timing frame images of the target temperature-sensitive phosphorescent particle emitting light in a flow field to be measured;
a second determining module configured to determine a velocity of the target temperature-sensitive phosphorescent particle based on the motion trajectory of the target temperature-sensitive phosphorescent particle in the particle timing frame images;
a third determining module configured to determine a decay-slope constant of the target temperature-sensitive phosphorescent particle based on the gray-level change of the target temperature-sensitive phosphorescent particle in the particle timing frame images;
a fourth determining module configured to determine a temperature of the target temperature-sensitive phosphorescent particle based on the decay-slope constant of the target temperature-sensitive phosphorescent particle and a predetermined correspondence, wherein the correspondence represents a correspondence between a decay-slope constant and a temperature of a temperature-sensitive phosphorescent particle; and
a fifth determining module configured to determine a velocity and a temperature of the flow field to be measured based on the velocity of the target temperature-sensitive phosphorescent particle and the temperature of the target temperature-sensitive phosphorescent particle.

10. A non-transitory computer-readable storage medium, storing computer-executable instructions that, when executed by a processor, cause the method according to claim 1 to be implemented.

11. The non-transitory computer-readable storage medium of claim 10, storing the computer-executable instructions that, when executed by a processor, cause following steps to be implemented:
performing enhancement processing on an initial particle timing frame image to obtain a first initial particle timing frame image;
performing dilation processing on the first initial particle timing frame image to obtain a second initial particle timing frame image;
comparing the first initial particle timing frame image with the second initial particle timing frame image to determine initial coordinates and gray levels of initial temperature-sensitive phosphorescent particles; and
determining, based on the initial coordinates and the gray levels of the initial temperature-sensitive phosphorescent particles, the motion trajectory and the gray-level change of the target temperature-sensitive phosphorescent particle.

12. The non-transitory computer-readable storage medium of claim 11, storing the computer-executable instructions that, when executed by a processor, cause following steps to be implemented:
performing screening for the initial temperature-sensitive phosphorescent particles based on the gray levels of the initial temperature-sensitive phosphorescent particles and a predetermined gray-level threshold, to obtain initial target temperature-sensitive phosphorescent particles, wherein the predetermined gray-level threshold is determined based on a type of the initial temperature-sensitive phosphorescent particles;
performing fitting processing on initial coordinates and gray levels of the initial target temperature-sensitive phosphorescent particles based on a two-dimensional Gaussian template, to obtain sub-pixel coordinates of the initial target temperature-sensitive phosphorescent particles;
determining, based on the sub-pixel coordinates of the initial target temperature-sensitive phosphorescent particles, a motion trajectory of the target temperature-sensitive phosphorescent particle; and
determining the gray-level change of the target temperature-sensitive phosphorescent particle based on the gray levels of the initial target temperature-sensitive phosphorescent particles.

13. The non-transitory computer-readable storage medium of claim 12, storing the computer-executable instructions that, when executed by a processor, cause following steps to be implemented:
determining sub-pixel coordinates of each initial target temperature-sensitive phosphorescent particle in a first initial target timing frame image to a fourth initial target timing frame image, wherein the first initial target timing frame image to the fourth initial target timing frame image are four image frames that are adjacent in time sequence;
determining an initial motion trajectory of the initial target temperature-sensitive phosphorescent particle based on the sub-pixel coordinates of the initial target temperature-sensitive phosphorescent particle in the first initial target timing frame image to the fourth initial target timing frame image;
determining a velocity of the initial target temperature-sensitive phosphorescent particle based on the initial motion trajectory of the initial target temperature-sensitive phosphorescent particle;
performing, based on velocities of the initial target temperature-sensitive phosphorescent particles, screening for the initial target temperature-sensitive phosphorescent particles to determine the target temperature-sensitive phosphorescent particle and the velocity of the target temperature-sensitive phosphorescent particle;
determining an acceleration of the target temperature-sensitive phosphorescent particle based on sub-pixel coordinates of the target temperature-sensitive phosphorescent particle in the first initial target timing frame image to the fourth initial target timing frame image; and
obtaining the motion trajectory of the target temperature-sensitive phosphorescent particle based on the velocity and the acceleration of the target temperature-sensitive phosphorescent particle.

14. The non-transitory computer-readable storage medium of claim 13, storing the computer-executable instructions that, when executed by a processor, cause following steps to be implemented:
determining the sub-pixel coordinates and corresponding neighboring particles of the initial target temperature-sensitive phosphorescent particle in the first initial target timing frame image, and first coordinate positions of the neighboring particles, wherein the neighboring particles represent particles within a preset distance from the initial target temperature-sensitive phosphorescent particle;
determining second coordinate positions of the neighboring particles in a second initial target timing frame image based on the initial target temperature-sensitive phosphorescent particle and the neighboring particles;
determining a target displacement based on the first coordinate positions and the second coordinate positions; and
determining sub-pixel coordinates of the initial target temperature-sensitive phosphorescent particle in a third initial target timing frame image and the fourth initial target timing frame image based on the sub-pixel coordinates of the initial target temperature-sensitive phosphorescent particle in the first initial target timing frame image and the target displacement.

15. The non-transitory computer-readable storage medium of claim 13, storing the computer-executable instructions that, when executed by a processor, cause following steps to be implemented:
determining velocities of the neighboring particles of the initial target temperature-sensitive phosphorescent particle;
determining a velocity range and a velocity-range median value of the neighboring particles based on the velocities of the neighboring particles;
determining a velocity residual range and a velocity-residual-range median value of the neighboring particles based on the velocities and the velocity-range median value of the neighboring particles;
determining a velocity residual of the initial target temperature-sensitive phosphorescent particle based on the velocities, the velocity-range median value, and the velocity-residual-range median value of the neighboring particles; and
performing screening for the initial target temperature-sensitive phosphorescent particles based on velocity residuals of the initial target temperature-sensitive phosphorescent particles and a predetermined velocity residual threshold, to determine the target temperature-sensitive phosphorescent particle from the initial target temperature-sensitive phosphorescent particles and the velocity of the target temperature-sensitive phosphorescent particle.

16. The non-transitory computer-readable storage medium of claim 10, storing the computer-executable instructions that, when executed by a processor, cause following steps to be implemented:
determining a gray level of the target temperature-sensitive phosphorescent particle in a target particle timing frame image; and
determining a luminescence lifetime and the decay-slope constant of the target temperature-sensitive phosphorescent particle based on a relationship between an emission intensity of the target temperature-sensitive phosphorescent particle and a time, and the gray level of the target temperature-sensitive phosphorescent particle in the target particle timing frame image and a corresponding target moment.

17. The non-transitory computer-readable storage medium of claim 10, storing the computer-executable instructions that, when executed by a processor, cause following steps to be implemented:
determining a fitting relationship between a flow-field temperature under a standard condition and a corresponding decay-slope constant; and
determining the temperature of the target temperature-sensitive phosphorescent particle based on the decay-slope constant of the target temperature-sensitive phosphorescent particle and the fitting relationship between the flow-field temperature under the standard condition and the corresponding decay-slope constant.
